(19) United States
(12) Patent Application Publication
(10) Pub. No.: US 2020/0198272 A1
(43) Pub. Date: Jun. 25, 2020

(54) TIRE WITH AN ENCAPSULATED SEALANT STRIP LAYER

(71) Applicant: The Goodyear Tire & Rubber Company, Akron, OH (US)

(72) Inventors: Hongbing Chen, Broadview Heights, OH (US); Christopher David Dyrlund, Canton, OH (US); Adam Mark Baldan, Akron, OH (US)

(21) Appl. No.: 16/661,117

(22) Filed: Oct. 23, 2019

Related U.S. Application Data
(60) Provisional application No. 62/781,761, filed on Dec. 19, 2018.

(51) Int. Cl. B29D 30/06; B60C 19/12; B29C 73/20; B29C 73/16

(52) U.S. Cl. CPC B29D 30/0685; B60C 19/12; B29C 73/20; B29D 2030/0698; B29D 2030/069; B29D 2030/0694; B29C 73/166

(57) ABSTRACT

One or more embodiments of the present invention provide a tire and method of forming a continuous encapsulated strip of sealant layer inside the tire. The strip of sealant layer has a varied mixture ratio of the sealant compound to the skin compound.

### FIELD OF THE INVENTION

The invention relates in general to tire manufacturing and, more particularly, to a tire having a layer of sealant, wherein the sealant layer is preferably a continuous strip of a first elastomer that is encapsulated by a second elastomer, and more particularly, to an encapsulated strip of sealant material.

### BACKGROUND OF THE INVENTION

Pneumatic tires with puncture sealing properties are known to those skilled in the tire art. Typically, such tires include a layer of sealant typically applied on the inside of the tire. The problem with a post cure applied sealant layer is that the sealant may migrate during high speed operation of the tire due to centrifugal forces. Thus, it is desired to have an improved tire having a layer of sealant that is formed from an encapsulated strip of sealant for installation on the inside of the tire.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a schematic view of a dual compound strip forming apparatus;

FIG. 2A is a close up view of a nozzle of the compound strip forming apparatus of FIG. 1, and FIG. 2B is a close up view of the nozzle outlet;

FIG. 3A is a side cross-sectional view of the nozzle of FIG. 2B;

FIG. 3B is a front view of the nozzle of FIG. 3A;

FIG. 3C is a side perspective view of the nozzle of FIG. 3A;

FIG. 3D is a cross section along the lines D-D of FIG. 3A;

FIG. 3E is a close up view of the circled portion of FIG. 3A;

FIG. 3F is a rear view of the nozzle;

FIG. 4A is a cross-sectional view of a nozzle of the present invention;

FIG. 4B is a cross-sectional view of a nozzle and removable insert;

FIG. 4C is a top perspective view of a removable insert;

FIG. 4D is a bottom perspective view of a removable insert;

FIG. 5A illustrates a 50-50 encapsulated strip, while FIG. 5B illustrates a 90-10 encapsulated strip;

FIG. 6A illustrates an encapsulated strip with a 90% sealant 10% outer layer;

FIG. 6B illustrates an encapsulated strip with an 80% sealant 20% outer layer;

FIG. 6C illustrates an encapsulated strip with a 50% sealant 50% outer layer;

FIG. 7 illustrates a first embodiment of a spirally wound encapsulated strip configuration of sealant;

FIG. 8 illustrates a cross-sectional view of the sealant configuration of FIG. 7; and

FIG. 9 illustrates a perspective view of a tire having a sealant on the inner surface of the tire.

### DETAILED DESCRIPTION OF THE INVENTION

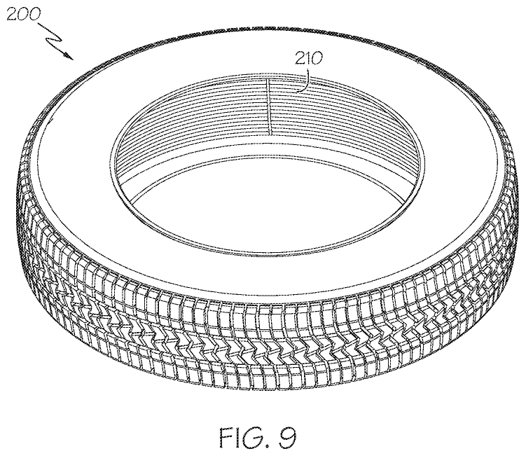

FIG. 9 illustrates a tire 200 of the present invention having a sealant layer 210 located on the inside layer of the tire, under the crown. The tire is conventional. The sealant layer 210 is formed by spirally winding a strip 220 such that the strips overlap with each other. Preferably, there is only a single layer of strips, as shown in FIG. 8. The strip is preferably continuous and is formed of encapsulated sealant, as described in more detail, below.

### Formation of the Encapsulated Strip of Sealant

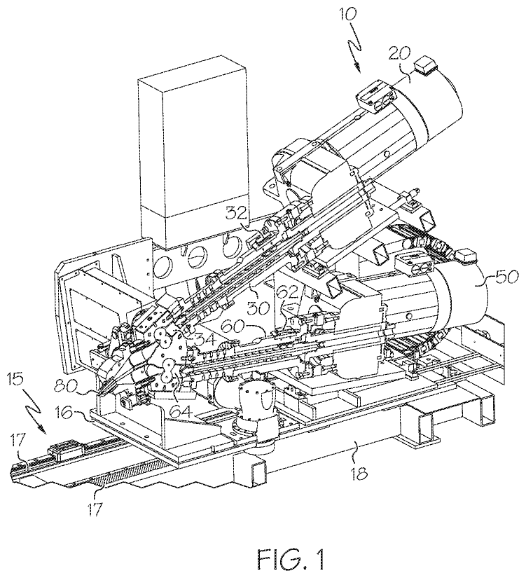

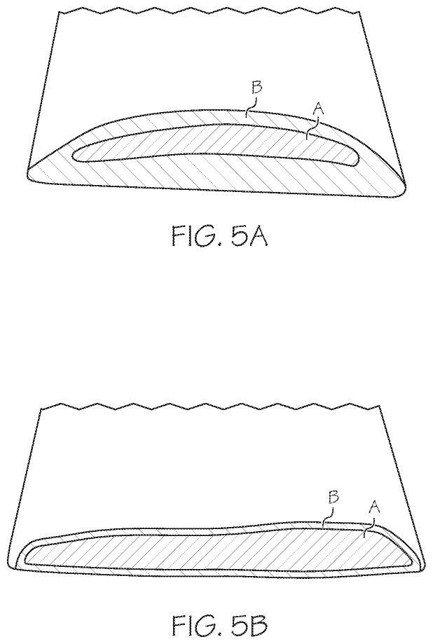

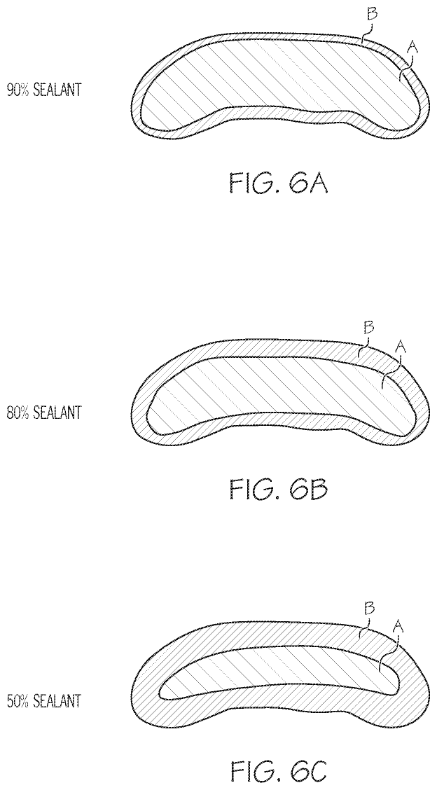

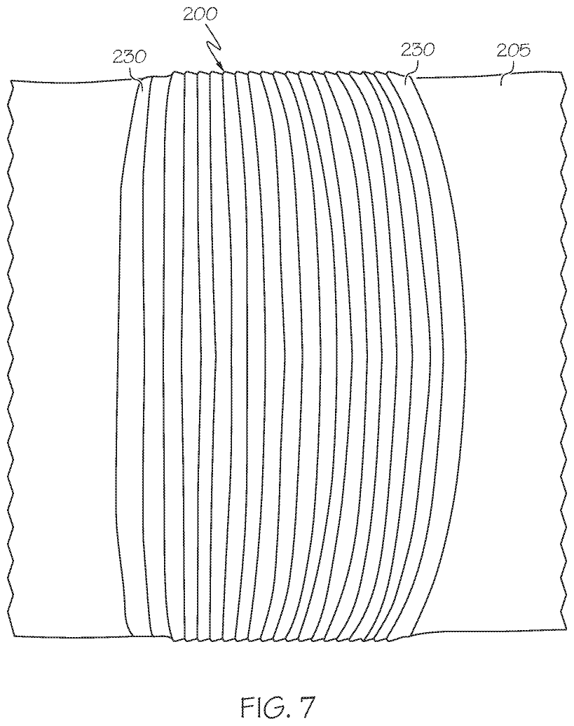

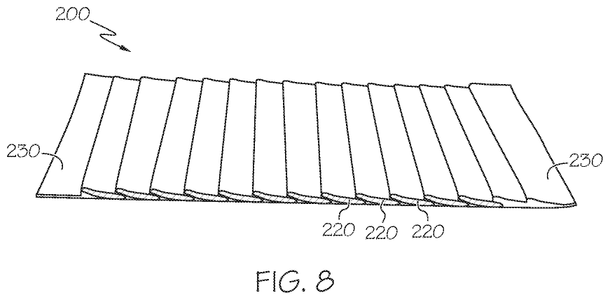

FIG. 1 illustrates a first embodiment of a dual compound strip forming apparatus 10 suitable for use for making a continuous strip of a first rubber compound A such as a sealant, that is encapsulated in a second rubber compound B as shown in FIGS. 5-6. The dual compound strip forming apparatus 10 is not limited to tire applications and may be used for example, to make other rubber components not related to tires such as conveyors, hoses, belts, etc. The dual compound strip forming apparatus 10 may be provided directly at the tire or component building station for direct application of the rubber composition to a tire, component, or other component building apparatus.

The dual compound strip forming apparatus 10 is mounted upon a translatable support bar 16 that is slidable fore and aft on parallel rails 17 of a support frame 18 so that the dual compound strip forming apparatus 10 can translate fore and aft in relation to a tire building machine (not shown).

As shown in FIG. 1A, the dual compound strip forming apparatus 10 includes a first extruder 30 and a second extruder 60, preferably arranged in a vertically stacked configuration as shown. The first extruder 30 has an inlet 32 for receiving a first rubber composition A as described in more detail, below. The first extruder 30 is driven by motor 20. The second extruder 60 has an inlet 62 for receiving a second rubber composition B as described in more detail, below. The second extruder 60 is driven by electrical motor 50. The first or second extruder 30,60 may comprise any commercial extruder suitable for processing of rubber or elastomer compounds. The extruder may comprise a commercially available extruder commonly known by those skilled in the art as a pin type extruder, a twin screw or a single screw extruder, or a ring type of extruder. Preferably, the extruder has a length to diameter ratio (L/D) of about 5, but may range from about 3 to about 20. A pin type of extruder is preferred, but is not limited to same.

The first extruder inlet 32 receives a first compound A, examples of which are described in more detail, below. The first extruder 30 functions to warm up a first compound A to the temperature in the range of about 80° C. to about 150° C., preferably about 90° C. to about 120° C., and to masticate the rubber composition as needed. The output end 34 of the first extruder 30 is connected to an inlet end 43 of a first gear pump 42. Compound A is thus first extruded by the first extruder 30 and then pumped by the first gear pump 42 into a nozzle 80. The first gear pump 42 functions as a metering device and a pump and may have gears such as planetary gears, bevel gears or other gears.

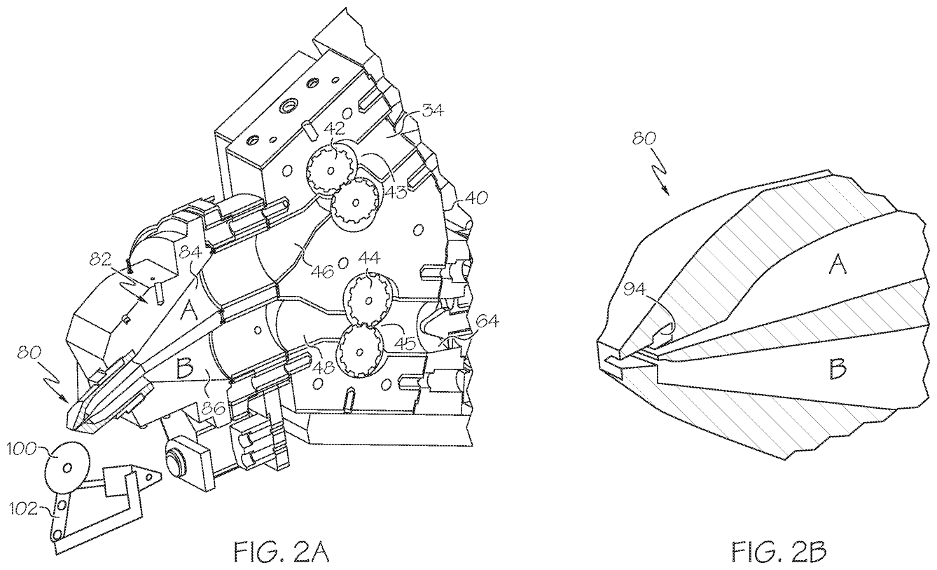

The second extruder inlet 62 receives a second compound B, examples of which are described in more detail, below. The second extruder 60 functions to warm up the second compound B to the temperature in the range of about 80° C. to about 150° C., preferably about 90° C. to about 120° C., and to masticate the rubber composition as needed. The output end 64 of the second extruder 60 is connected to an inlet end 45 of a second gear pump 44 as shown in FIG. 2A. Compound B is thus extruded by the second extruder 60 and then pumped by the second gear pump 44, which functions as a metering device and a pump and may have gears such as planetary gears, bevel gears or other gears.

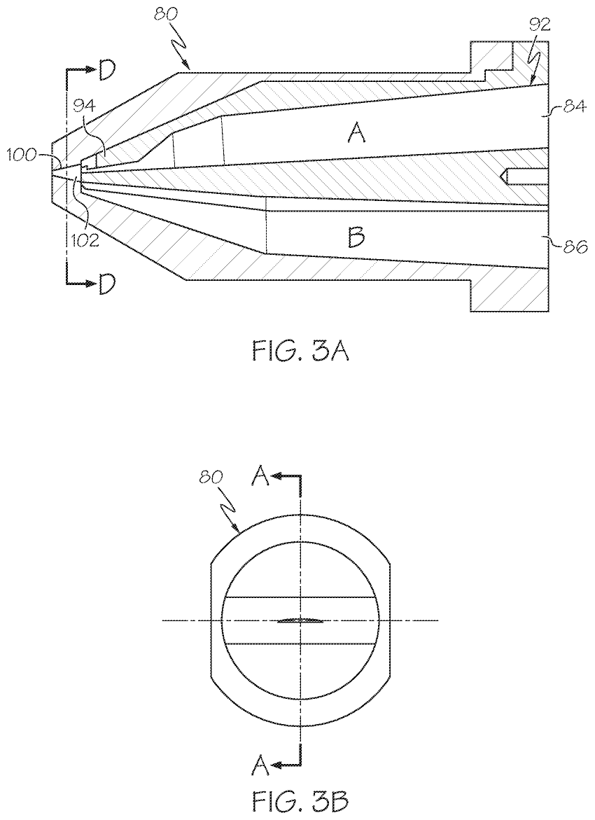

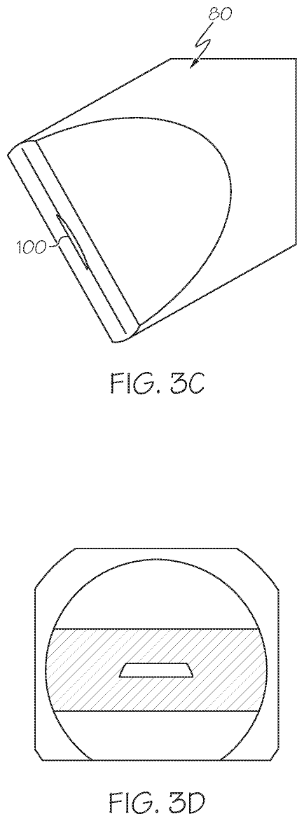

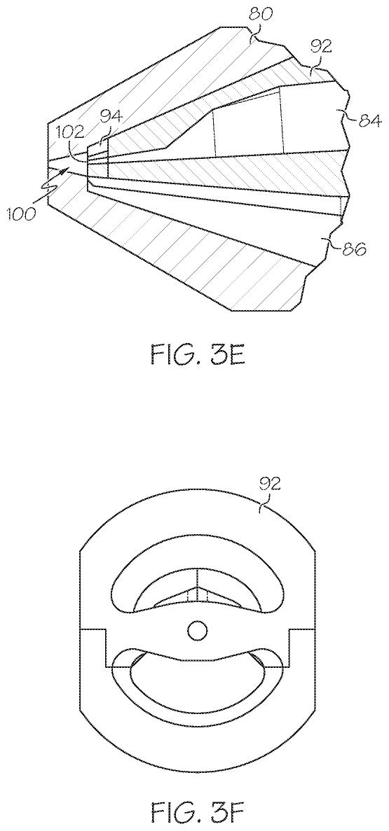

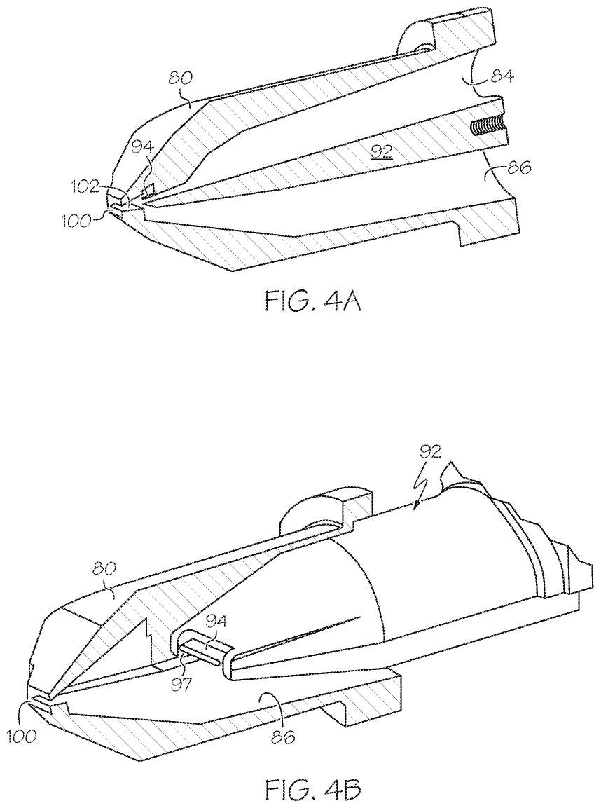

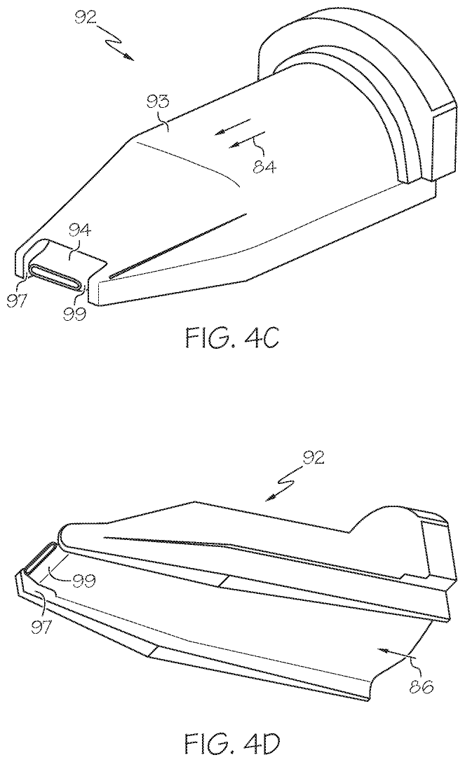

The first and second gear pumps 42,44 may be housed in a single housing 40 and are placed in close proximity to each other so that the outlet channels 46,48 of the first and second gear pumps are also in close proximity, as shown in FIG. 2A. The gear pump outlet channels 46,48 are fed into respective first and second nozzle channels 84,86 of nozzle 80. FIG. 3A illustrates a cross-sectional side view of the nozzle 80. The first and second nozzle channels 84,86 are formed by a removable insert 92 that is used to separate the internal flow passageways 88,90. FIG. 4C illustrates the upper surface 93 of the removable insert 92 that forms the first nozzle channel 84 that flows the compound A to be encapsulated. The removable insert 92 has an upper surface that terminates in an elongated flat portion 94 that is located at the entrance to the die 102. There are two slits or short passageways 97,99 on each side of the elongated flat portion 94 of the insert that facilitates the encapsulation flow of compound B around compound A.

The first and second nozzle channels 84,86 remain separated from each other so that the two rubber flow streams do not merge until the exit of the nozzle. At the entrance to the flow die 102, the compound B flow stream flows around the compound A stream so that a continuous strip of compound A is encapsulated by a thin skin of compound B. Thus, the flow streams of compound A and B do not mix together to form a mixed compound.

Thus, the apparatus of the invention produces an encapsulated continuous strip of compound A that is encapsulated by skin of compound B. An example strip is shown in FIG. 5b, with the yellow sealant being 90% of the mixture and being encapsulated by an outer shell or skin of 10% by volume of the mixture. FIG. 5A illustrates 50% of the yellow sealant being encapsulated by an outer shell of 50% by volume of the mixture. FIGS. 6A-6C illustrate side by side comparison of varying amounts of sealant.

The volume ratio of compound A to compound B may be altered, as shown in FIG. 6A with 90% compound A, 10% compound B, while FIG. 6B illustrates 80% compound A, 20% compound B, and FIG. 6C illustrates 50% A, 50% B. The volume ratio of A to B is varied by varying the ratio of the speed of gear pump A to gear pump B.

In one embodiment, the sealant material suitable for use is described in U.S. Pat. No. 4,359,078, or U.S. Pat. No. 6,837,287 in in US application Ser. No. 10/917,620, which is hereby incorporated by reference. The outer skin material is selected to bond readily to the inner liner or other layers of the tire. Preferably, the skin material has the same composition as one of the tire components to which the sealant strip is bonded to.

A method for forming a continuous strip of compound of a sealant encapsulated by a gum rubber comprises the steps of: extruding the sealant compound through a first extruder and then pumping the sealant through a first gear pump and into a first passageway of a nozzle, while at the same time extruding a gum rubber through a second extruder and then pumping the gum rubber through a second gear pump and into a second passageway of a nozzle, wherein the first and second passageways are joined together at the inlet of the die outlet of a nozzle. Preferably, the first and second compound exit the die outlet of the nozzle wherein the sealant is encapsulated by the gum rubber. The nozzle preferably has a removable insert which divides the nozzle into a separated first and second passageway, wherein the removable insert has a distal end for positioning adjacent a die outlet of the nozzle, wherein the distal end has an elongated flat portion. Preferably there are slits located on each end of the elongated flat portion to facilitate encapsulation of the flow. More preferably, the ratio of the volume of the encapsulated rubber to the volume of the skin is varied by changing the ratio of the speed of the first gear pump to the second gear pump.

### Formation of the Sealant Layer in a Green Tire

A first embodiment of a method of forming a sealant layer is shown in FIG. 7 and in FIG. 8. Using the dual compound strip forming apparatus 10, an encapsulated strip 220 of sealant is spirally wound onto a tire building drum 205. The strips are partially overlapped with each other as shown in FIG. 7. At the lateral edges 230 of the sealant configuration 200, there are at least one, preferably two windings of 100% gum rubber, such as barrier gum rubber, at each lateral edge 230. The width of each strip is in the range of 3-5 mm, and is shown at 3.5 mm. The lateral edges may range from 70% to 100% gum or barrier rubber, with the balance being sealant.

After the strips are spirally wound on the drum, the strips are cut, pulled off the drum, and then the ends are spliced together and manually inserted in the tire.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising a carcass layer, an inner liner located radially inward of the carcass layer, and a sealant layer, wherein the sealant layer is formed by spirally winding a strip of encapsulated sealant.

2. The pneumatic tire of claim 1 wherein the sealant layer is formed from a single layer of strips.

3. The pneumatic tire of claim 1 wherein the strips are overlapped with each other.

4. The pneumatic tire of claim 1 wherein the ratio of sealant to gum rubber is varied in the sealant layer.

5. The pneumatic tire of claim 1 wherein the strips at the lateral edges contain no sealant.

6. The pneumatic tire of claim 1 wherein the one or more strips at the lateral edges are in the range of 70% to 100% gum rubber.

7. The pneumatic tire of claim 1 wherein the one or more strips inside the lateral edges are in the range of 70% to 100% sealant.

8. The pneumatic tire of claim 1 wherein the cross-sectional shape of the strip is rectangular.

9. The pneumatic tire of claim 1 wherein the sealant layer is located radially inward of the inner liner.
